(19) United States
(12) Patent Application Publication
(10) Pub. No.: US 2012/0296990 A1
(43) Pub. Date: Nov. 22, 2012

(54) SHARED CONTENT SERVER FOR ELECTRONIC MESSAGES

(76) Inventor: Robert G. UOMINI, Kensington, CA (US)

(21) Appl. No.: 13/354,266

(22) Filed: Jan. 19, 2012

Related U.S. Application Data
(63) Continuation-in-part of application No. 13/108,962, filed on May 16, 2011.

(51) Int. Cl. G06F 15/16

(52) U.S. Cl. 709/206

(57) ABSTRACT

Methods, apparati, and computer-readable media for reducing the total amount of disk space used by multiple recipients of an electronic message in a communications network. The present invention removes the requirement that all recipients (35) of electronic messages be enabled to receive dynamic content, by moving the responsibility for dealing with dynamic content out of the recipients (35) and into inbound and outbound servers (34, 32).

### RELATED APPLICATION

This patent application is a continuation-in-part of U.S. patent application Ser. No. 13/108,962 filed May 16, 2011 entitled “Method for Reduction of Disk Space Usage of Electronic Messages in a Network”, which patent application is hereby incorporated by reference in its entirety into the present patent application.

### TECHNICAL FIELD

This invention pertains to the field of sending and receiving electronic messages, such as e-mails, in communications networks.

### BACKGROUND ART

Electronic messaging has become an essential form of communication in the age of the Internet. With the surge in usage of electronic media, such as e-mail, an increased burden has been placed on the resources needed to manage this data traffic, including data storage devices. Efficiencies in this area have come from many sources, including the technology described in the invention protected by U.S. Pat. No. 5,815,663 (Distributed posting system using an indirect reference protocol), referred to herein as “dynamic content”.

One shortcoming of dynamic content technology, as applied to e-mail, is that all e-mail sent to multiple recipients assumes that recipient e-mail clients are enabled to read dynamic content e-mail. But not all recipients are so enabled. The present invention removes this requirement by moving the responsibility for dealing with dynamic content out of the e-mail client and into the outbound and inbound e-mail servers. Thus, all e-mail clients are now able to participate in the advantages of dynamic content without requiring any modifications to the client.

### DISCLOSURE OF INVENTION

This invention eliminates redundant electronic messages in a network caused by copying a message to multiple recipients, without requiring code changes in the messaging client 31 code. Specifically, a message sent by a user messaging client, such as an e-mail client 31, is received by a receiving server, such as an SMTP server 32, which then stores the message content with a content server 10. The content server 10 returns a pointer to the content, as described in U.S. Pat. No. 5,815,663, which the receiving server 32 then may insert into the message header, in place of the message content, before sending the message to the message recipient(s) 35. When a recipient 35 receives a message and wishes to read it, the associated inbound messaging server, such as an IMAP or POP mail server 34, uses the pointer contained in the message to retrieve the message content from the content server 10 and return it to the recipient 35.

### BRIEF DESCRIPTION OF THE DRAWINGS

These and other more detailed and specific objects and features of the present invention are more fully disclosed in the following specification, reference being had to the accompanying drawings, in which:

FIG. 1 is a flowchart illustrating a process of reading a message according to the present invention.

FIG. 2 is a flowchart illustrating a process of sending a message according to the present invention.

FIG. 3 is a block diagram showing modules of the present invention.

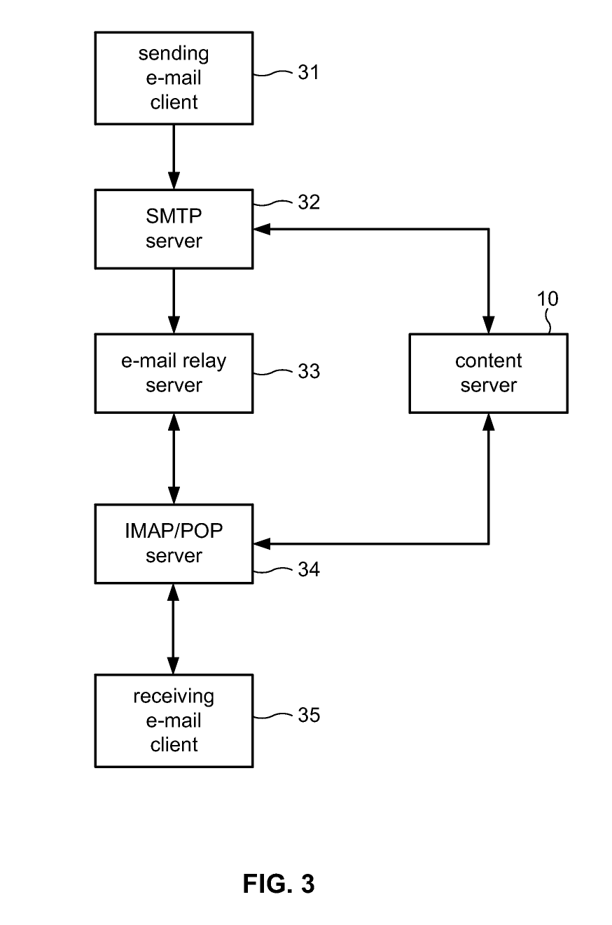

### DETAILED DESCRIPTION OF THE PREFERRED EMBODIMENTS

The preferred embodiment that is illustrated herein is for electronic mail, and includes an SMTP server 32, an IMAP or POP server 34 (collectively, “e-mail servers”), and a content server 10 communicating with the e-mail servers 32, 34 via HTTP. A preferred implementation is based on the Apache James Server (see http://james.apache.org/ for details), modified to support the functionality as described herein. In the entire network, there is only one content server 10. Server 10 is not tied to a particular SMTP server 32 or IMAP/POP server 34. All recipients 35 need to have registered with content server 10 in order to access it. This is why there are passwords in the RECEIVE CONTENT and FETCH CONTENT commands (see below).

We now describe the operation of the outbound (SMTP) server 32 and inbound (IMAP/POP) server 34 separately.

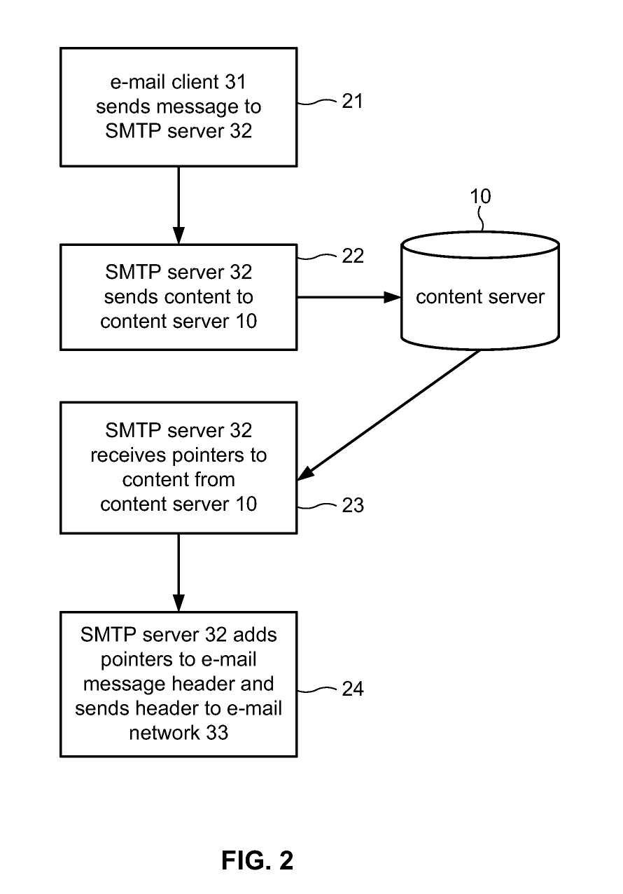

### Sending a Message Using SMTP Server 32 (See FIG. 2)

The sending messaging client 31 (normally software) can reside on a desktop device, mobile device, or laptop device.

When a message is sent from the sending e-mail client 31 to the SMTP server 32 (at step 21), the server 32 first checks to see which of the recipients 35 are able to receive dynamic content; this could be done via a configuration table. For example, one or more of the recipients 35 may have mailboxes on a non-dynamic-content-enabled IMAP/POP server 34. If all recipients 35 are on an appropriately-configured James Server 34, such recipients 35 would all be able to view dynamic content.

For recipients 35 who are NOT able to receive dynamic content, the server 32 simply performs the usual SMTP functions and forwards the message to the appropriate e-mail relay server 33 for that recipient 35. If the recipient 35 is able to receive dynamic content, the SMTP server 32 sends (at step 22) to the content server 10 one RECEIVE CONTENT request for each content component in the message, the content server 10 stores the content on storage means (such as a hard disk) associated with server 10, and server 10 returns to the SMTP server 32 (at step 23) pointers to the locations of the respective content components on the server 10.

The RECEIVE CONTENT command is typically formatted as follows. All command parameters are separated by a blank character.

RECEIVE CONTENT <e-mail address> <password> <recipients> <content> where <e-mail address> is the user's 31 e-mail address, <password> is the content server 10 password and is sent Base64 encoded, <recipients> is a comma-delimited list of recipient 35 e-mail addresses, and <content> is the Base64-encoded content of the message body or an attachment. One RECEIVE CONTENT command is sent to the content server 10 for each attachment or content, including the main body of the message.

The server 10 responds with one of the following (no double-quotes):
“−17 Unable to determine user data limit”
“−14 User data limit exceeded:”
“−13 Error fetching content file length, e:”
“−12 Missing recipient list”
“−10 Invalid number of parameters”
“−5 Error writing to content or index file, e:”
“−4 Error opening content file, e:”
“−3 Error opening content index file, e:”
“−2 Login not complete”
“2 Content saved, key =”

In the above, the data following “key =” is a pointer (address) to the message content in the content server 10 database. Error messages may be accompanied by additional details.

The pointer information includes numeric values corresponding to the content components in the content server 10 database. This pointer information, along with the name and port number of the content server 10, are added to the mail message header by the SMTP server 32, and the SMTP server 32 sends (at step 24) the header to the recipient(s) 35. Note that the message body is empty in this implementation.

A standard (“canned”) message can be included in the message body before the SMTP server 32 sends the message to the recipient(s). The purpose of such a canned message is to aid in error detection. The canned message could be something like: “If you are seeing this message, it is because this server is not properly configured for dynamic content or you have not registered with the content server.”

The message can be free from attachments, or it can contain one or more attachments. In some embodiments, no content is included in the message body when SMTP server 32 sends the message. In other embodiments, the original message from e-mail client 31 is included in the message body when SMTP server 32 sends the message. In still other embodiments, a customized message is included in the message body before SMTP server 32 sends the message.

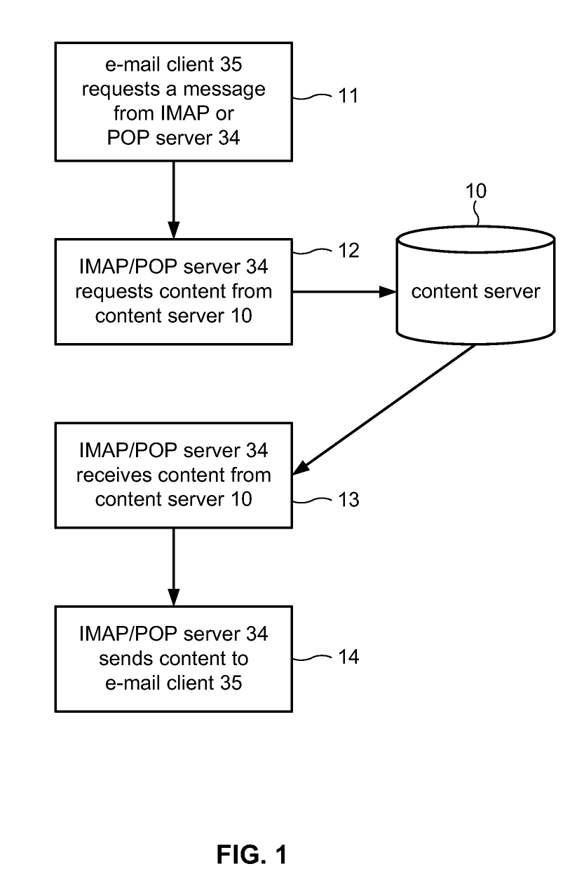

### Reading a Message Using IMAP/POP Server 34 (See FIG. 1)

The receiving e-mail client 35 (normally software) can reside on a laptop device, mobile device, or desktop device. The IMAP/POP server 34 can reside on a desktop device, a server, a laptop, or a mobile device.

When a user of client 35 wishes to view an e-mail message in the user's inbox, the user typically selects the message to be viewed from within a window that displays certain summary information about the message, such as the date received, the sender e-mail address or name, and the message subject. The e-mail client 35 (at step 11) sends a request to the IMAP or POP server 34 to retrieve the message body, and this in turn causes the IMAP/POP server 34 to query the message header for dynamic content information. If there is no dynamic content information in the header, server 34 assumes that the message requested does not contain dynamic content, and the IMAP or POP server 34 performs the usual function of fetching and returning the content from the cognizant e-mail relay server 33. If, on the other hand, the pointer information is present in the header, the pointer information is retrieved and used by the IMAP/POP server 34 to format and send (at step 12) a FETCH CONTENT request to the content server 10, which returns the desired content to the IMAP/POP server 34 at step 13. Similarly, if a dynamic content attachment is selected for viewing, the pointer for the attachment is used in the FETCH CONTENT request. At step 14, the IMAP/POP server 34 sends the message to the receiving e-mail client 35.

The FETCH CONTENT command is typically formatted as follows. All command parameters are separated by a blank character.

FETCH CONTENT <e-mail address> <password> <source e-mail> <key> where <e-mail address> is the user's 35 e-mail address, <password> is the content server 10 password and is sent Base64 encoded, <source e-mail> is the e-mail address of the sender 31 of the message, and <key> is a pointer to the message in the content server 10 database.

The content server 10 responds with one of the following (no double-quotes):
“−15 Not a number, key:”
“−11 Not a recipient, e-mail address:”
“−6 Error reading content file, e:”
“−4 Error opening content file, e:”
“−3 Error opening content index file, e:”
“−2 Login not complete”
“3 Content fetched, content =”

Error messages may be accompanied by additional details. A normal response is appended with the requested message content, which had previously been sent Base64-encoded.

The message sent from IMAP/POP server 34 to receiving e-mail client 35 may be devoid of attachments; or it may include one or more attachments.

The method steps described herein are typically embodied in modules. The modules can consist of any combination of hardware, firmware, and/or software. When embodied in software, the software can reside on one or more computer-readable media, such as one or more hard disks, floppy disks, thumb drives, optical disks, etc.

The above description is included to illustrate the operation of the preferred embodiments, and is not meant to limit the scope of the invention. The scope of the invention is to be limited only by the following claims. From the above discussion, many variations will be apparent to one skilled in the art that would yet be encompassed by the spirit and scope of the present invention.

What is claimed is:

1. A method for sending electronic messages in a communications network, the method comprising an outbound messaging server performing the steps of:
receiving an outbound message from a client;
sending content contained in the message to a content server;
receiving from the content server at least one content pointer that points to the content as stored by the content server;
adding the content pointer(s) to a message for at least one recipient; and
sending the resulting message(s) to the recipient(s) over the network.

2. The method of claim 1, wherein the outbound messaging server includes a standard (“canned”) message in the outbound message before sending the message to the network.

3. The method of claim 1, wherein the message contains no attachments.

4. The method of claim 1, wherein the message contains at least one attachment.

5. The method of claim 1, wherein no content is included in the message body before the message is sent to the network.

6. The method of claim 1, wherein the outbound message is included in the message before the message is sent to the network.

7. The method of claim 1, wherein a customized message is included in the message before the message is sent to the network.

8. The method of claim 1, wherein the client resides on a desktop device.

9. The method of claim 1, wherein the client resides on a mobile device.

10. The method of claim 1, wherein the client resides on a laptop device.

11. The method of claim 1, wherein the outbound messaging server resides on a mobile device.

12. The method of claim 1, wherein the outbound messaging server resides on a desktop device.

13. The method of claim 1, wherein the outbound messaging server resides on a laptop device.

14. The method of claim 1, wherein the outbound messaging server resides on a server device.

15. A method for reading electronic messages in a communications network, the method comprising an inbound messaging server performing the steps of:
receiving a request from a messaging client to read a message;
examining a header of the message for at least one pointer to message content;
when at least one pointer is present in the header, fetching the message content, using the pointer(s), from a content server; and
sending the message, including the content, to the client.

16. The method of claim 15, wherein the client resides on a laptop device.

17. The method of claim 15, wherein the client resides on a mobile device.

18. The method of claim 15, wherein the client resides on a desktop device.

19. The method of claim 15, wherein the inbound messaging server resides on a server.

20. The method of claim 15, wherein the inbound messaging server resides on a desktop.

21. The method of claim 15, wherein the inbound messaging server resides on a laptop.

22. The method of claim 15, wherein the inbound messaging server resides on a mobile device.

23. The method of claim 15, wherein the message content includes no attachments.

24. The method of claim 15, wherein the message content includes at least one attachment.

25. At least one computer-readable medium containing computer program instructions for sending electronic messages in a communications network, said instructions directing an outbound messaging server to perform the steps of:
receiving an outbound message from a client;
sending content contained in the message to a content server;
receiving from the content server at least one content pointer that points to the content as stored by the content server;
adding the content pointer(s) to a message for at least one recipient; and
sending the resulting message(s) to the recipient(s) over the network.

26. At least one computer-readable medium containing computer program instructions for reading electronic messages in a communications network, said instructions directing an inbound messaging server to perform the steps of:
receiving a request from a messaging client to read a message;
examining a header of the message for at least one pointer to message content;
when at least one pointer is present in the header, fetching the message content, using the pointer(s), from a content server; and
sending the message, including the content, to the client.

27. Apparatus for sending and receiving electronic messages in a communications network, said apparatus comprising:
means for sending electronic messages;
means for receiving electronic messages;
coupled to the sending means, means for determining whether the receiving means is able to receive dynamic content;
coupled to the receiving means, means for ascertaining whether dynamic content is present in the electronic message; and
coupled to the determining means and to the ascertaining means, means for storing content contained in the electronic message.
